(19) United States
(12) Patent Application Publication
(10) Pub. No.: US 2016/0110460 A1
(43) Pub. Date: Apr. 21, 2016

(54) SEARCH EVALUATION SYSTEM

(71) Applicant: TARGET BRANDS INC., Minneapolis, MN (US)

(72) Inventors: Chris JOHNSON, Plymouth, MN (US); David KLEIN, St. Paul, MN (US); Dakota Reese BROWN, St. Paul, MN (US)

(21) Appl. No.: 14/519,778

(22) Filed: Oct. 21, 2014

(51) Int. Cl. G06F 17/30; G06F 3/048

(52) U.S. Cl. CPC G06F 17/30867; G06F 17/3053; G06F 3/048

(57) ABSTRACT

An electronic search evaluation system and method are disclosed. The system includes an application loadable onto a user device including a display and an input, and a server in communication with the user device. The application, when loaded onto the user device, permits the user device to communicate with the server to send to the server baseline and candidate search configurations, and a plurality of search terms, and to receive from the server, baseline and candidate search results for the search terms, and to cause display of the search results on the display. The server configured to receive the search configurations and search terms, identify the search results, compare the search results, and send the search results to the application. The search results sent to the application including a comparison marker to indicate whether the search results are matching.

### BACKGROUND

Online shopping is a continuously growing industry. A user engaging in online shopping can locate potential products of interest in a number of ways, including, but, not limited to, conducting searches through a search engine embedded into a website of a retailer. Generally, the user expects that a search will return the most relevant products based on the search terms provided. In order to return the most relevant products, retailers often perform search evaluation in order to determine whether the search results corresponding to a particular input term/terms include the most relevant products to the user (including ordering the products so that the most relevant products are included at the beginning of the search results). Improved ways of search evaluation for various search configurations are desirable.

### SUMMARY

An electronic search evaluation system is disclosed. The electronic search evaluation system includes an application that is loadable onto a user device that includes a display and an input and a server in communication with the user device. The application, when loaded onto the user device, permits the user device to communicate with the server to send to the server a baseline search configuration, a candidate search configuration, and a plurality of search terms, and to receive from the server baseline search results and candidate search results for the plurality of search terms, and to cause display of the baseline search results and candidate search results on the display. The server is communicable with the user device and configured to receive the baseline and candidate search configurations and search terms, identify the baseline and candidate search results, compare the baseline and candidate search results, and send the baseline and candidate search results to the application. The baseline and candidate search results sent to the application include a comparison marker to indicate whether the baseline and candidate search results are matching.

A method of evaluating a search configuration is disclosed. The method includes providing a search evaluation system that is loadable onto a user device having an input and a display, the search evaluation system permitting a user to create and/or modify search configurations, configure search evaluation parameters, execute search evaluations for a plurality of search terms, and review and score search results for the search configurations and the plurality of search terms. The method further includes receiving, by a server, the plurality of search terms, a baseline search configuration, and a candidate search configuration from the search evaluation system. The method includes obtaining a baseline search results list and a candidate search results list for each of the plurality of search terms, wherein the baseline search results lists correspond to the baseline search configuration and the candidate search results lists correspond to the candidate search configuration. The method further includes comparing the baseline search results list with the candidate search results list for each of the plurality of search terms and, based on the comparing, generating a discrepancy list of search terms wherein the baseline search results list and the candidate search results lists are not the same; and sending the discrepancy list and search details associated with the search terms in the discrepancy list to the user device for display on the display in a side-by-side breakdown.

A graphical user interface (GUI) for a search evaluation system displayed on a display of a user device is disclosed. The GUI includes one or more servers connectable to a network and configured to provide a search evaluation system interface for evaluating a plurality of search configurations, the search evaluation system interface viewable on a user device and displaying a plurality of search results lists for a plurality of search terms and the plurality of search configurations, the plurality of search configurations including a baseline search configuration and a candidate search configuration, the plurality of search results lists including a baseline search result list and a candidate search result list for each of the plurality of search terms.

### BRIEF DESCRIPTION OF THE FIGURES

References are made to the accompanying drawings that form a part of this disclosure and which illustrate the embodiments in which the systems and methods described in this Specification can be practiced.

FIG. 1 is a schematic diagram of a system for implementing the search evaluation system as described herein, according to some embodiments.

FIGS. 2A-2D illustrate configuration user interfaces for the search evaluation system as described herein, according to some embodiments.

FIG. 3A illustrates a test execution configuration user interface for the search evaluation system as described herein, according to some embodiments.

FIG. 3B illustrates a test execution results summary user interface for the search evaluation system as described herein, according to some embodiments.

FIG. 4A illustrates a detailed comparison user interface for the search evaluation system as described herein, according to some embodiments.

FIG. 4B illustrates another portion of the detailed comparison user interface illustrated in FIG. 4A, according to some embodiments.

FIG. 4C illustrates a score comparison results summary user interface for the search evaluation system as described herein, according to some embodiments.

FIGS. 5A-5C illustrate summary scorecard user interfaces for the search evaluation system as described herein, according to some embodiments.

FIG. 6 is a flowchart for a method to evaluate a search configuration using the search evaluation system described herein, according to some embodiments.

FIG. 7 is a schematic diagram for an architecture for a computing device, according to some embodiments.

Like reference numbers represent like parts throughout.

### DETAILED DESCRIPTION

This disclosure generally relates to the field of search engine evaluation. More specifically, this disclosure relates to a search evaluation system and method for evaluating a plurality of search configurations. In some embodiments, search evaluation can alternatively be referred to as search query tuning or the like. In some embodiments, the search evaluation system can enable a user to evaluate a plurality of search configurations. In some embodiments, the search evaluation system enables a user to compare one or more search results sets (e.g., a list of products returned to a user entering a search into a search engine of a website of a retailer). Generally, the user may be a member of a retailer (e.g., an employee). In some embodiments, the user may not be a member of the retail organization, but may assist the retailer with search evaluation (e.g., through a third party testing system or the like). Comparing the one or more search results sets can enable the user to identify the effect of tuning or modifying a search engine.

Search evaluation can be critical for a retailer. The difference between a consumer making a purchase via a retailer's website and moving on to a different retailer's website without making a purchase can be influenced by whether a search of the retailer's website returns products most relevant to the search terms input by the consumer. For example, if a consumer searches for “diapers” on the retailer's website, and the search results returned do not include diapers near the beginning of the returned search results, the consumer may interpret this to mean that the retailer does not carry the product for which she is shopping. As a result, the consumer may shop at another retailer's website, thereby causing a loss of sales due to what the consumer views as incorrect search results.

In general, a retailer may carry a large number of products. As a result, a search configuration can be relatively successful (e.g., provides the more relevant products near the beginning of the search results) for one search term and corresponding product, and relatively less successful (e.g., does not provide the more relevant products near the beginning of the search results) for another search term and corresponding product. Accordingly, the retailer generally performs search engine evaluation. A search evaluation system and method are disclosed in which a user (e.g., employee of the retailer, or the like) can evaluate a plurality of search configurations for a plurality of search terms. This can enable the retailer to identify a search configuration which is relatively successful for the plurality of products the retailer sells. In some embodiments, the retailer can make the search evaluation system (or a limited portion of the search evaluation system) available to users who are not associated with the retailer in order to, for example, expand the scope of the search evaluation.

A “button,” as used in this Specification, is not intended to require a particular type of display. For example, a button can include a clickable button, a hyperlink, or the like. A button is an area of a graphical user interface (GUI) that is clickable or otherwise selectable by a user in any manner in order to perform an action.

A “search evaluation system,” as used in this Specification, is a website, application, or other system including at least one server that is connectable to a network and that is configured to provide a GUI that is viewable on a user device. The search evaluation system can enable configuration and testing of a plurality of search configurations to identify a preferred search configuration for a retail website.

A “search index,” as used in this Specification, is a particular search strategy that includes, for example, but is not limited to, one or more particular fields to search, the order in which the fields should be searched, or the like.

A “ranking strategy,” as used in this Specification, includes a particular search relevance strategy. A ranking strategy can determine how search results are identified using a particular search index. For example, the search index can define what fields are to be searched, and the ranking strategy can identify what is matched for the fields searched, the order in which the results are returned, or the like.

A “website,” as used in this Specification, is a website system including at least one server that is connectable to the Internet and that is configured to provide a website that is viewable on the Internet. The website displays a plurality of products and product images that can be searched using a search engine to identify products a consumer would like to purchase.

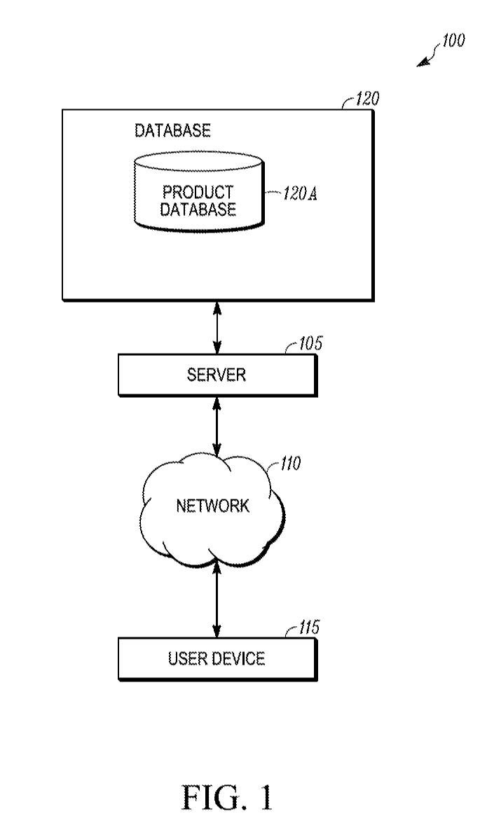

FIG. 1 is a schematic diagram of a system 100 for implementing a search evaluation system as described herein, according to some embodiments. In the system 100, a server 105 is connected in communication with a user device 115 via a network 110.

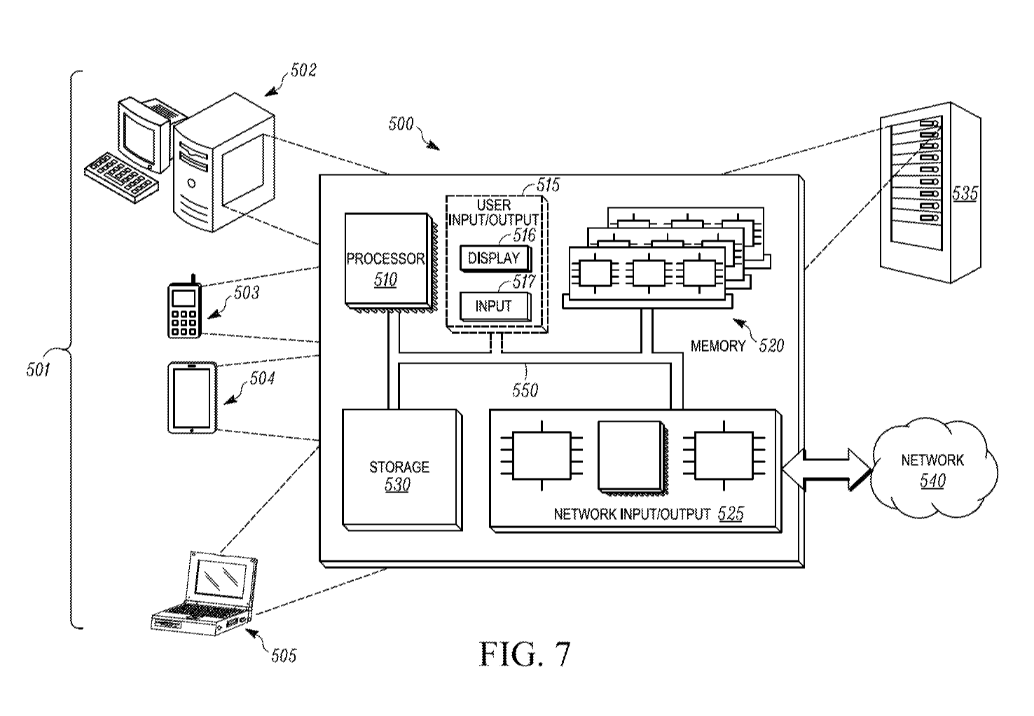

The server 105 makes the search evaluation system available over the network 110 according to principles known in the art for allowing a user to access and view a user interface (e.g., a website or the like) with the user device 115. In some embodiments, aspects of the server 105 can be the same as or similar to aspects of a server device 535 as described in accordance with FIG. 7 below.

The network 110 is generally representative of the Internet. The network 110 can include, for example, a local area network (LAN), a wide area network (WAN), a wireless network, a cellular data network, or the like. In some embodiments, aspects of the network 110 can be the same as or similar to aspects of a network 540 as described in accordance with FIG. 7 below.

A user can evaluate impacts of modifying a search configuration by accessing the search evaluation system via the network 110 and the user device 115. Examples of the user device 115 include, but are not limited to, a personal computer (PC), a laptop computer, a mobile device (e.g., a smartphone, a personal digital assistant (PDA), or the like), or a tablet-style device. A graphical user interface (GUI) of the search evaluation system is displayed on a display of the user device 115. Examples of the display for the user device 115 include, but are not limited to, a monitor connected to a PC, a laptop screen, a mobile device screen, a tablet screen, or the like. In some embodiments, aspects of the user device 115 can be the same as or similar to aspects of the user devices 501 as described in accordance with FIG. 7 below.

The server 105 is in communication with a database 120. The database 120 can generally include a variety of information such as, but not limited to, information about products available through a website of a retailer. A product database 120A can store information about the various products. Examples of information about the various products include, for example, details about a product (e.g., a product name, product description, product images, pricing, or the like). The database 120 can include additional information such as, but not limited to, search terms which have been used in the search evaluation system, user information (e.g., usernames, passwords, or the like) for controlling user access to the search evaluation system, or the like.

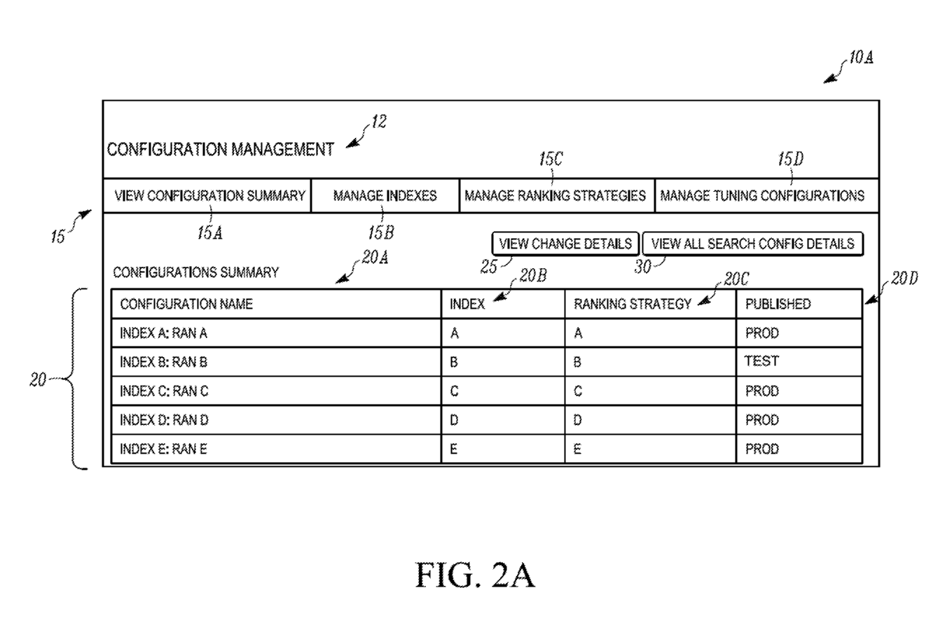

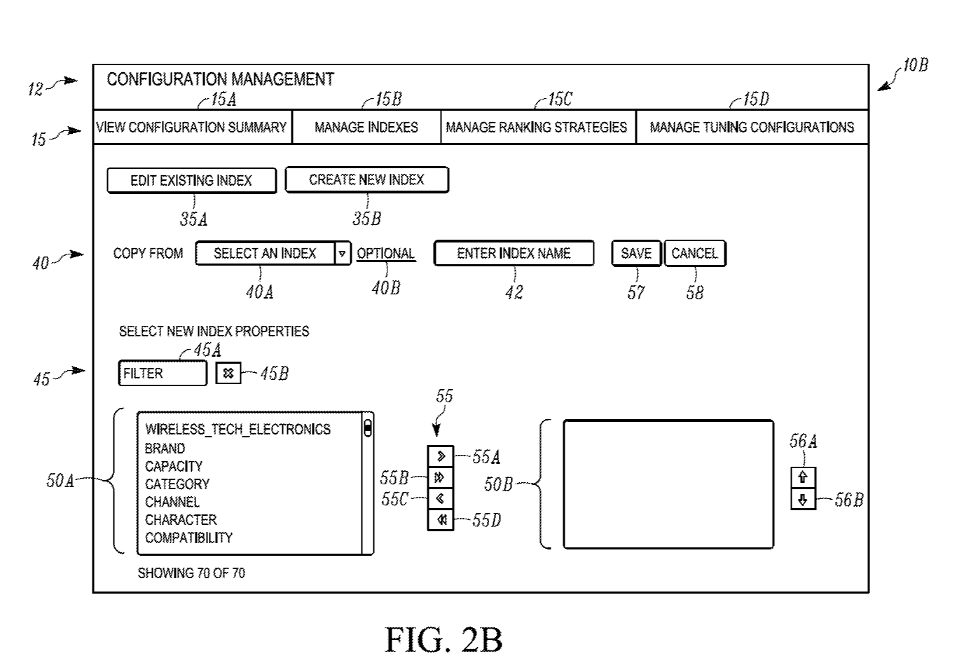

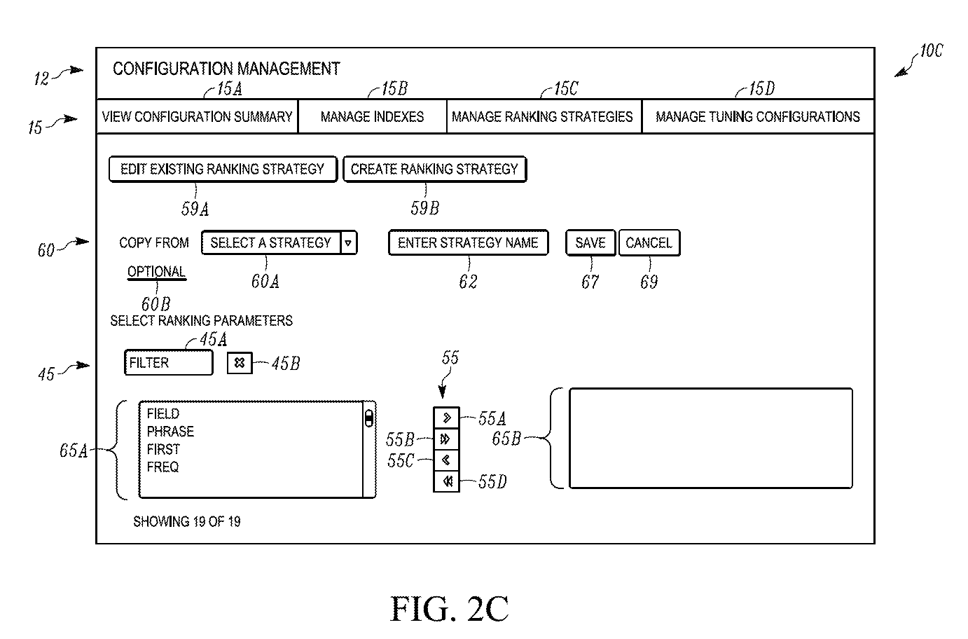

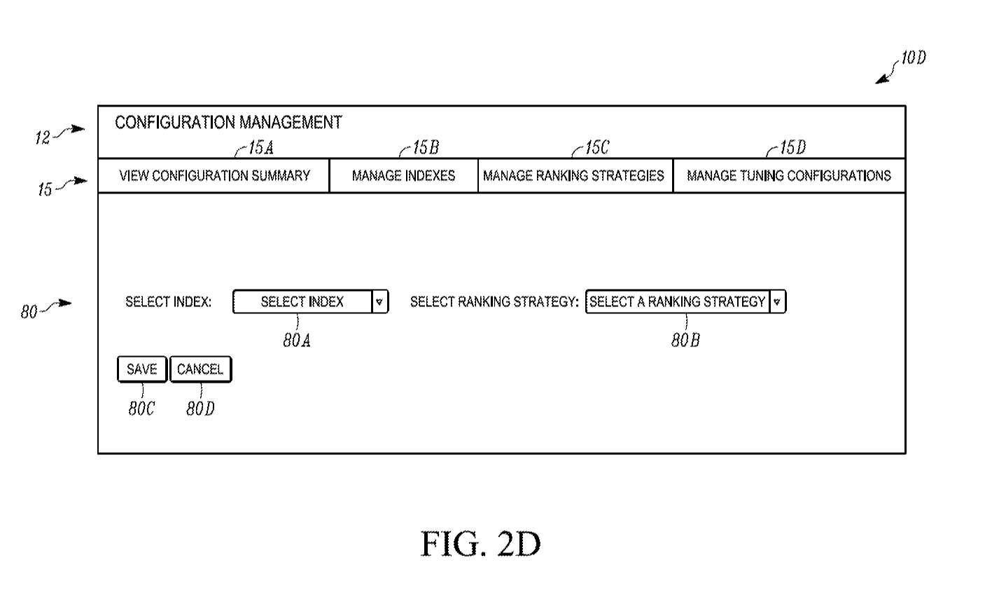

FIGS. 2A-2D illustrate configuration user interfaces 10A-10D for a search evaluation system as described herein, according to some embodiments. In some embodiments, the configuration user interfaces 10A-10D can alternatively be referred to as the configuration management interfaces 10A-10D or the like. The text, arrangement of the text, and the like, are intended to serve as examples for the configuration user interfaces 10A-10D and can vary according to the principles described in this Specification. Four configuration user interfaces 10A-10D corresponding to configuring the search evaluation system are illustrated. It is to be appreciated that this number can vary according to design. For example, the four configuration user interfaces 10A-10D can be combined into fewer than four user interfaces (e.g., a single configuration user interface) or can be separated into more than four user interfaces, according to some embodiments. In some embodiments, the configuration user interfaces 10A-10D can be designed based on a particular search engine that is to be evaluated. That is, input fields, options, or the like, can be tailored to the particular search engine. In some embodiments, the configuration user interfaces 10A-10D can be designed independently of the search engine being evaluated, which can, in some embodiments, provide flexibility of the search evaluation system to be used to test various search engines. In some embodiments, the search evaluation system can include additional functionality such as, but not limited to, including in a search configuration one or more query classifier properties. In some embodiments, this can, for example, enable testing of the query classifier as well as the search engine configuration.

A user can generally configure/setup a plurality of search configurations to be evaluated through the configuration user interfaces 10A-10D. The configuration user interfaces 10A-10D generally include a title 12 and a tabular selection menu 15. The title 12 can be indicative of the configuration action to be taken for the particular interface. For example, in the illustrated embodiment, the configuration user interfaces 10A-10D include the title 12 “Configuration Management.” It is to be appreciated that the title 12 is one example and can be modified.

The tabular selection menu 15 includes tabs 15A-15D corresponding to the configuration user interfaces 10A-10D. That is, each of the configuration user interfaces 10A-10D correspond to a selection of one of the tabs 15A-15D. The configuration user interface 10A of FIG. 2A corresponds to the “View Configuration Summary” tab 15A. The configuration user interface 10B of FIG. 2B corresponds to the “Manage Indexes” tab 15B. The configuration user interface 10C of FIG. 2C corresponds to the Manage Ranking Strategies” tab 15C. The configuration user interface 10D of FIG. 2D corresponds to the “Manage Tuning Configurations” tab 15D.

The tabs 15A-15D are intended as an example and can be modified, according to some embodiments. For example, there can be fewer or additional tabs, the tabs can include alternative names, or the like. In some embodiments, the configuration user interfaces 10A-10D can alternatively be combined into a single configuration user interface having a single tab including a combination of the features on the tabs 15A-15D. The tabs 15A-15D can include a visual indicator to visually notify the user which of the configuration user interfaces 10A-10D is currently displayed. Examples of visual indicators include, but are not limited to, a text color, a text emphasis (e.g., bolded, italicized, underlined, or the like), a tab background color, or the like.

FIG. 2A illustrates the configuration user interface 10A that corresponds to the “View Configuration Summary” tab 15A, according to some embodiments. The configuration user interface 10A includes a configuration summary table 20, a button 25, and a button 30. The configuration user interface 10A can include fewer or additional text, images, buttons, or the like.

The configuration summary table 20 includes a tabular breakdown of search configurations available in the search evaluation system. Each row of the illustrated configuration summary table 20 corresponds to a search configuration (e.g., the illustrated embodiment includes five different search configurations). It is to be appreciated that fewer or additional search configurations can be included in the configuration summary table 20. The number of search configurations included in the configuration summary table 20 can, for example, be based on the number of search configurations that have been created in the search evaluation system, according to some embodiments. The configuration summary table 20 can include the most frequently used search configurations. In such embodiments, the button 30 can be included to enable the user to view all search configurations. In some embodiments, the configuration user interface 10A can be scrollable such that additional search configurations are viewable by the user. In some embodiments, as additional search configurations are created, the configuration summary table 20 can be updated. In some embodiments, as search configurations are modified, the configuration summary table 20 can be updated to include the modified search configuration details. The configuration summary table 20 may not be modified when a modification to a search configuration does not impact the information displayed in the configuration summary table 20. Modification to the search configurations are described in additional detail in accordance with FIGS. 2B-2D below.

The configuration summary table 20 includes four columns 20A-20D. The configuration summary table 20 can include fewer or additional columns, according to some embodiments. The columns 20A-20D include information particular to a search configuration (e.g., a particular row of the configuration summary table 20). A column 20A includes a “Configuration Name.” The column 20A can include a name representative of a particular search configuration. The search configurations in FIG. 2A include names that incorporate a search index, which is identified in column 20B, and a ranking strategy, which is identified in column 20C, selected for the particular search configuration. Accordingly, for the first row of the configuration summary table 20, the column 20A includes the search configuration name INDEX A:RAN A (e.g., “Index” A (column 20B) and “Ranking Strategy” A (column 20C)). A column 20D includes a “Published” value. The column 20D can indicate a system in which the search configuration is available. For example, the search configurations in the configuration summary table 20 are either available in a “Test” system or a “Prod” (production) system. There may be one or more additional systems in which the search configurations are available.

FIG. 2B illustrates the configuration user interface 10B that corresponds to the “Manage Indexes” tab 15B, according to some embodiments. The configuration user interface 10B generally enables a user to create a new search index and/or modify an existing search index to be evaluated. In some embodiments, the user can copy details of an existing search index into a new search index. This can, for example, allow the user to modify an existing search index without losing the previous setup for the existing search index.

The configuration user interface 10B includes configuration mode buttons 35A-35B, copy options 40, an interface name input 42, filter options 45, search index properties configuration boxes 50A-50B, interface properties toggle buttons 55, interface property reordering buttons 56A-56B, and buttons 57-58.

The user can edit an existing search index or create a new search index. The configuration button 35A is selectable to modify an existing search index. Alternatively, the configuration button 35B is selectable to create a new search index. The illustrated embodiment is directed to creating a new search index (e.g., a situation in which the user has selected the configuration button 35B). The configuration user interface 10B can include one or more different options (not shown) when the user selects the configuration button 35A in order to edit an existing search index. For example, the copy options 40 may be replaced with an option enabling the user to select an existing search index from a list of existing search indexes which, when selected, can populate one or more properties of the search index into the selected search index properties field 50B. The method by which the user can select an existing search index is not intended to be limiting and can, for example, alternatively be a text box or the like. The manner in which the user can edit the existing search index can function the same as or similar to the manner in which the user configures a new search index.

When the user is creating a new search index, the copy options 40 can be displayed. The copy options 40 can include a selection means 40A for selecting an existing search index. As illustrated, the selection means 40A can be a drop-down list, though any suitable selection means can be used. Suitable selection means include, but are not limited to, a text input in which the user can input a name of an existing search index, a radio button list via which the user can select an existing search index, or the like. The indicator 40B identifies the copy options 40 as being optional. Accordingly, the user can create a new search index by copying an existing search index or, alternatively, can create a new search index without copying from an existing search index.

The user can input a search index name at the index name input 42. There may be naming requirements such as, but not limited to, maximum/minimum number of characters, type of characters (e.g., letters, numbers, of the like), or the like. In some embodiments, the search evaluation system can include one or more validations based on the one or more naming requirements. These validations can function according to principles known in the art.

The configuration user interface 10B includes the search index properties configuration boxes 50A-50B. The search index properties configuration box 50A corresponds to available search index properties, and the search index properties configuration box 50B corresponds to search index properties which have been selected for the search index being configured. The search index properties boxes 50A-50B can be scrollable so that the various search index properties can be browsed and selected. The filter options 45 can reduce the amount of scrolling/searching to find a particular search index property. To accomplish this, the user can input text into the filter input 45A in order to limit the search index properties being displayed to those similar to the input text. The input text can be cleared by deleting the text or by selecting the filter clear button 45B. The filter options 45 function according to principles known in the art.

To configure the search index, the user selects from the available search index properties in the search index properties configuration box 50A. The selected search index properties can be added to the search index being configured, as visually represented by moving the selected search index properties to the search index properties configuration box 50B. When one or more search index properties in the search index properties configuration box 50A have been selected, the user can select button 55A to move that selection to the search index properties configuration box 50B (and accordingly, to the search index being configured). The user can alternatively select button 55B to move all search index properties from the search index properties configuration box 50A to the search index properties configuration box 50B without individually selecting from the available search index properties. Similarly, the user can select button 55C to remove one or more selected search index properties from the search index properties configuration box 50B of button 55D to remove all search index properties from the search index properties configuration box 50B. The buttons 56A-56B can be used to reorder the search index properties in the search index properties configuration box 50B, thereby changing the order of the properties in the search index and modifying the search configuration.

Once the search index has been named and configured, button 57 can be selected to save the search index or button 58 can be selected to cancel the search index without saving. In some embodiments, the button 57 may only be selectable when one or more of the configuration details are completed (e.g., when a name has been input and at least one search index property has been included in the search index properties configuration box 50B).

FIG. 2C illustrates the configuration user interface 10C corresponding to the “Manage Ranking Strategies” tab 15C, according to some embodiments. The configuration user interface 10C generally enables the user to create a new ranking strategy or to modify an existing ranking strategy. In some embodiments, the user can select to modify a ranking strategy in order to make modifications to an existing ranking strategy. In some embodiments, the user can create a new ranking strategy by copying an existing ranking strategy. It is to be appreciated that the ranking strategy configuration can function the same as or similar to the search index configuration. Further, aspects of FIG. 2C can be the same as or similar to aspects of FIGS. 2A-2B. For simplicity of this Specification, those aspects that have already been described will not be described in additional detail.

The user can select button 59A to modify an existing ranking strategy. Alternatively, the user can select button 59B in order to create a new ranking strategy. The illustrated embodiment shows the configuration user interface 10C when the user has selected the button 59B (to create a new ranking strategy).

When the user is creating a new ranking strategy, the copy options 60 can be displayed. The copy options 60 can include a selection means 60A for selecting an existing ranking strategy. As illustrated, the selection means 60A can be a drop-down list, though any suitable selection means can be used. Suitable selection means include, but are not limited to, a text input in which the user can input a name of an existing ranking strategy, a radio button list via which the user can select an existing ranking strategy, or the like. The indicator 60B identifies the copy options 60 as being optional. Accordingly, the user can create a new ranking strategy by copying an existing ranking strategy or, alternatively, can create a new ranking strategy without copying from an existing ranking strategy.

The user can input a ranking strategy name at the interface name input 62. There may be naming requirements such as, but not limited to, maximum/minimum number of characters, type of characters (e.g., letters, numbers, or the like), or the like. In some embodiments, the search evaluation system can include one or more validations based on the one or more naming requirements. These validations can function according to principles known in the art.

The configuration user interface 10C includes the ranking strategy properties configuration boxes 65A-65B. The ranking strategy properties configuration box 65A corresponds to available ranking strategy properties, and the ranking strategy properties configuration box 65B corresponds to ranking strategy properties which have been selected for the ranking strategy being configured. The ranking strategy properties boxes 65A-65B can be scrollable so that the various ranking strategy properties can be browsed and selected. The filter options 45 can reduce the amount of scrolling/searching to find a particular ranking strategy property.

To configure the ranking strategy, the user selects from the available ranking strategy properties in the ranking strategy properties configuration box 65A. The selected ranking strategy properties can be added to the ranking strategy being configured, as visually represented by moving the selected ranking strategy properties to the ranking strategy properties configuration box 65B. When one or more ranking strategy properties in the ranking strategy properties configuration box 65A have been selected, the user can select button 55A to move that selection to the ranking strategy properties configuration box 65B (and accordingly, to the ranking strategy being configured). The user can alternatively select button 55B to move all ranking strategy properties from the ranking strategy properties configuration box 65A to the ranking strategy properties configuration box 65B without individually selecting from the available ranking strategy properties. Similarly, the user can select button 55C to remove one or more selected ranking strategy properties from the ranking strategy properties configuration box 65B or button 55D to remove all ranking strategy properties from the ranking strategy properties configuration box 65B. In some embodiments, the configuration user interface 10C can include one or more additional buttons, such as the buttons 56A-56B (FIG. 2B), which can be used to reorder the ranking strategy properties in the ranking strategy properties configuration box 65B, thereby changing the order of the properties in the ranking strategy.

Once the ranking strategy has been named and configured, button 67 can be selected to save the ranking strategy or button 69 can be selected to cancel the ranking strategy without saving.

FIG. 2D illustrates the configuration user interface 10D corresponding to the “Manage Tuning Configurations” tab 15D, according to some embodiments. The configuration user interface 10D generally enables the user to create a new search configuration. The new search configuration can, for example, be selected based on the search indexes and the ranking strategies created through the configuration user interfaces 10A-10B (FIGS. 2B-2C) as described above.

The configuration user interface 10D includes search configuration options 80. The search configuration options 80 include a search index selection 80A and a ranking strategy selection 80B. In the illustrated embodiment, the search index selection 80A and the ranking strategy selection 80B are drop-down lists. The drop-down lists 80A-80B can be populated based on the information entered when creating the search indexes and the ranking strategies as described in accordance with FIGS. 2B-2C above. It is to be appreciated that the search configuration options 80 could, for example, be other types of inputs, such as, but not limited to, a text box or the like. In embodiments in which the inputs are text boxes or the like, an additional validation may be added to ensure that the user has input a search index and a ranking strategy that is available within the search evaluation system. Once a search index is selected from the search index selection 80A and a ranking strategy is selected from the ranking strategy selection 80B, the user can select a button 80C to save the search configuration. Alternatively, the user can select a button 80D to cancel the creation of the search configuration without saving. The search configuration can, for example, be saved to a database (e.g., database 120 of FIG. 1) that includes the various search configurations that have been created for use with the search evaluation system.

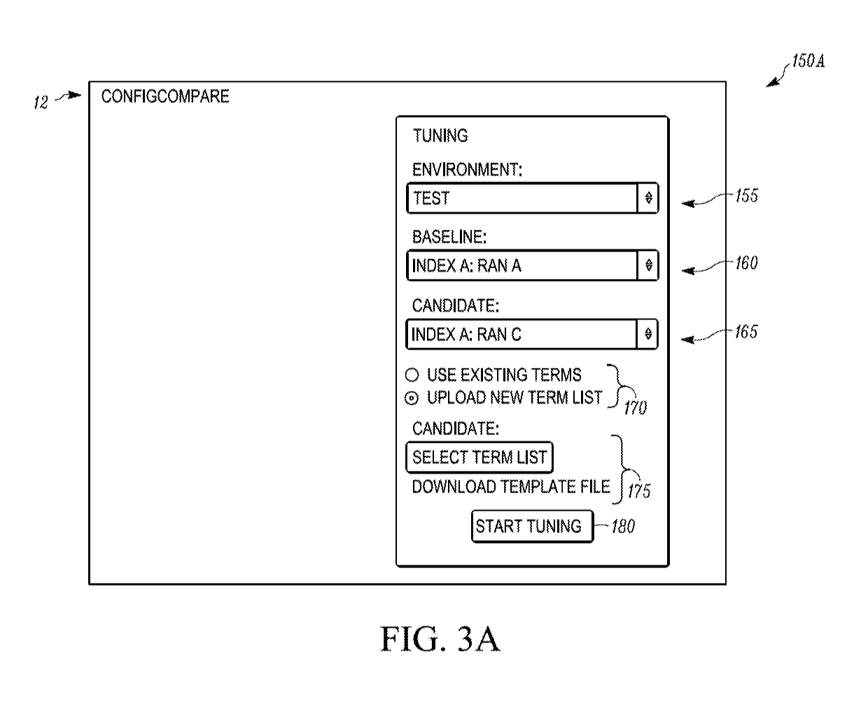

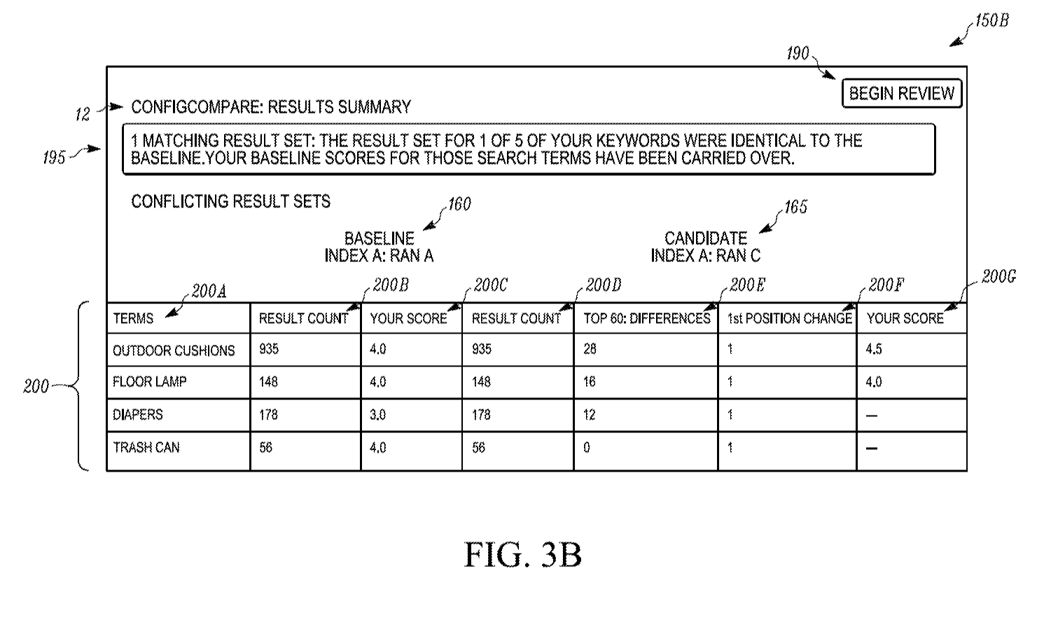

FIG. 3A illustrates a test execution configuration user interface 150A of the search evaluation system as described herein, according to some embodiments. Aspects of FIG. 3A can be the same as or similar to aspects of FIGS. 2A-2D. For simplicity of this Specification, aspects of FIGS. 2A-2D previously described will not be discussed in additional detail. In some embodiments, the look and feel of the test execution configuration user interface 150A can be the same as or similar to the look and feel of the configuration user interfaces 10A-10D.

The test execution configuration user interface 150A includes a plurality of options for configuring a test to be run via the search evaluation system. Through the test execution configuration user interface 150A, an environment is selectable from an environment selection 155. Examples of selections for the environment include, but are not limited to, a “Test” environment, a “Prod” (production) environment, or the like. The environment can, for example, indicate a system in which a test is to be performed. The choices for the environment selection 155 can, in some embodiments, be the same as the systems included in the column 20D (FIG. 2A). It is to be appreciated that the testing environment selection 155 can be other forms of inputs, such as, but not limited to, a text box or the like.

To configure the search evaluation system for a test, a baseline search configuration can be selected from a baseline selection 160 and a candidate search configuration can be selected from a candidate selection 165. The baseline selection 160 and the candidate selection 165 are illustrated as drop-down lists and can include options as configured in the configuration user interface 10D. The search configurations selectable in the baseline selection 160 and the candidate selection 165 can, for example, be limited to those search configurations available on the system(s) selected in the environment selection 155.

The selected baseline search configuration and candidate search configuration can be used to review search results based on existing search terms (e.g., search terms previously tested and/or uploaded into the search evaluation system) or a new search term list, which can be loaded into the search evaluation system at the time of execution. The search terms which will be evaluated are based on a search term selection 170. Existing search terns may have been previously reviewed and stored, for example, in a database (e.g., database 120 of FIG. 1) of search terms that can be reused in subsequent testing.

The search term list may require a specific format (e.g., field names, column orders, or the like) in order to be input without errors into the search evaluation system. In some embodiments, the user may be able to select a link to “Download Template File” in order to receive a sample search term list. If the user has a search term list, the user can select the “Select Term List” button 175 in order to upload the list of search terms to be reviewed. Once the user has configured all fields, the user can select the “Start Timing” button 180 in order to perform the search evaluation. In some embodiments, if the user has not uploaded a search term list or has not selected baseline and candidate search configurations, a notification can be presented to the user to indicate that further configuration is required before the test can be performed.

Once the user has selected the “Start Tuning” button 180, the search evaluation system completes a search for each search term based on the selected baseline and candidate search configurations. To perform the search, the search evaluation system may, for example, submit a search query to a search engine, including submitting the baseline and candidate search configurations. The search engine can provide a search results list for each term and each of the baseline and candidate search configurations. When complete, the search evaluation system can display the test execution results summary user interface 150B (FIG. 3B).

FIG. 3B illustrates a test execution results summary user interface 150B for the search evaluation system as described herein, according to some embodiments. Aspects of FIG. 3B can be the same as or similar to aspects of FIGS. 2A-2D and FIG. 3A. For simplicity of this Specification, aspects of FIGS. 2A-2D and FIG. 3A previously described will not be discussed in additional detail. In some embodiments, the look and feel of the test execution results summary user interface 150B can be the same as or similar to the look and feel of the configuration user interfaces 10A-10D and the test execution configuration user interface 150A.

The test execution results summary user interface 150B can include a test results message 195. The search results message 195 can indicate whether search results gathered using the baseline search configuration for a particular search term were the same as the search results gathered using the candidate search configuration for the particular search term. In some embodiments, the test execution results summary user interface 150B displays the search results for search terms for which the baseline and candidate search configurations returned different search results. In some embodiments, the search results can include a comparison marker to indicate whether a particular search term includes matching search results for the baseline and candidate search configurations. The search evaluation system can compare the search results to determine discrepancies between baseline search results and candidate search results for a particular term in a variety of manners. For example, the top search results (e.g., the first N results, where N represents an integer) can be compared against each other, or the like. In some embodiments, a total number of search results returned can be compared. In some embodiments, the comparison means may be configurable by the user. In the illustrated embodiment, for example, the results set for one search term was not included in the displayed search results.

A summary table 200 includes the search results for each of the search terms 200A which do not match between the baseline search configuration and the candidate search configuration. It is to be appreciated that the test execution results summary user interface 150B can be modified such that all search results (even those which match) are included in the summary table 200. The summary table 200 includes a breakdown of a baseline result count 200B, a baseline score 200C, a candidate result count 200D, a top differences count 200E, a first position change 200F, and a candidate score 200G for each of the different terms 200A. The baseline score 200C is generally representative of a numerical score given by the particular user for the baseline search configuration and a particular search term. In order to select a search configuration as the baseline search configuration, a user may be required to provide a score for the particular search term using the search configuration. That is, in some embodiments, a search configuration may be selectable as a baseline search configuration when the user has previously evaluated the search configuration. In some embodiments, a baseline score 200C is provided by uploading a baseline score file. In some embodiments, a baseline score 200C can be completed within the search evaluation system. For example, in some embodiments, if a baseline score 200C has not been provided when a user selects the baseline search configuration, the user may be required to complete scoring of the baseline search configuration before proceeding. As illustrated, the baseline result count 200B and the candidate result count 200D may be the same.

The user can select button 190 in order to begin reviewing the search results in additional detail. By selecting the button 190, the user can review the search results, evaluate the candidate search configuration, and provide a candidate score to the candidate search configuration.

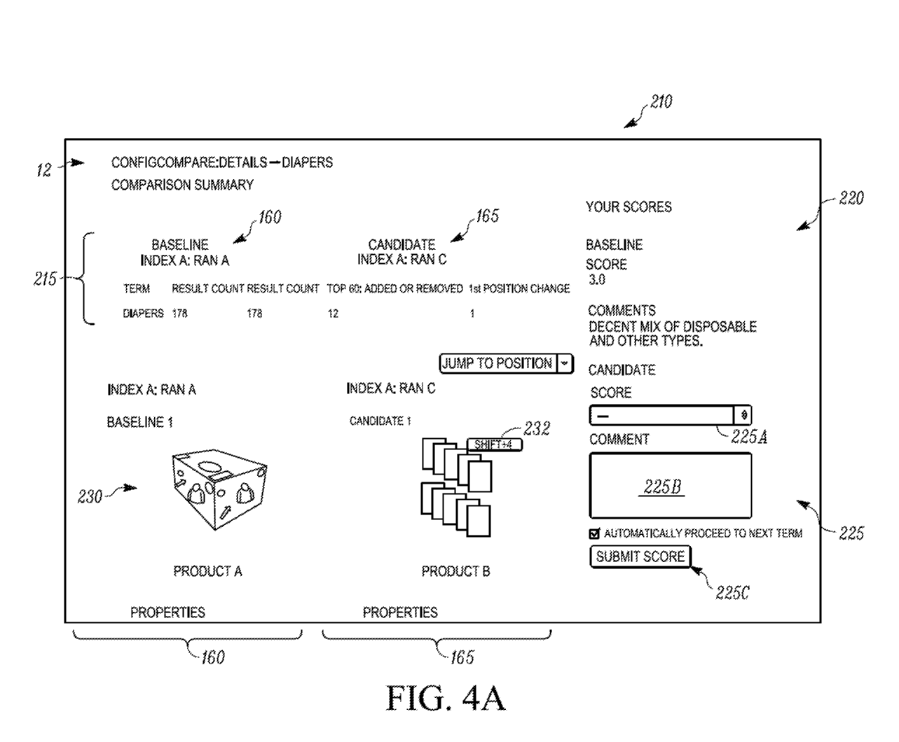

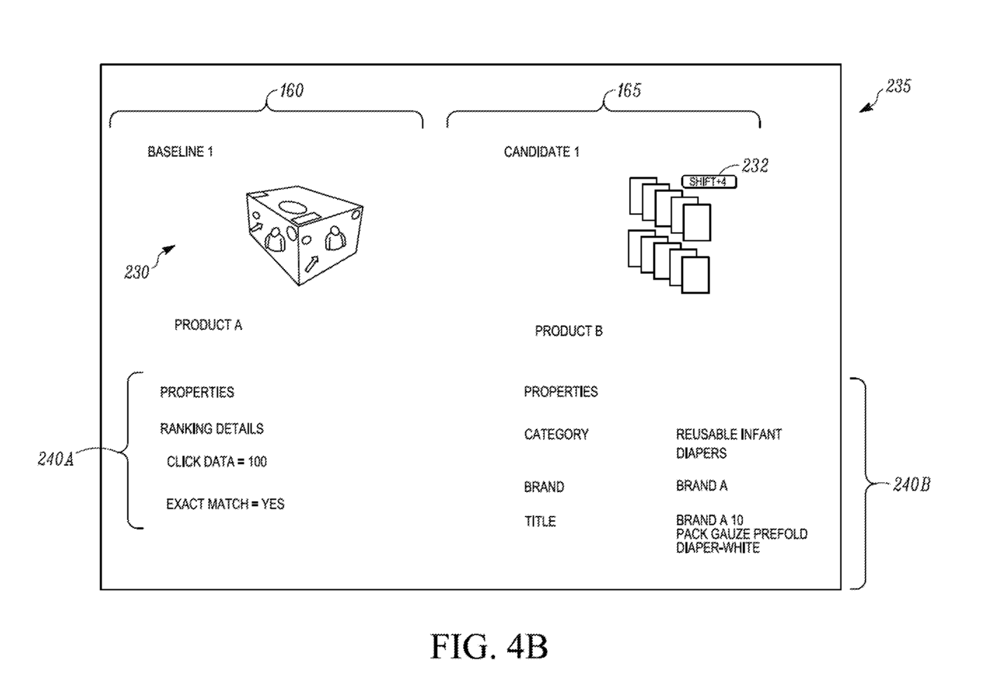

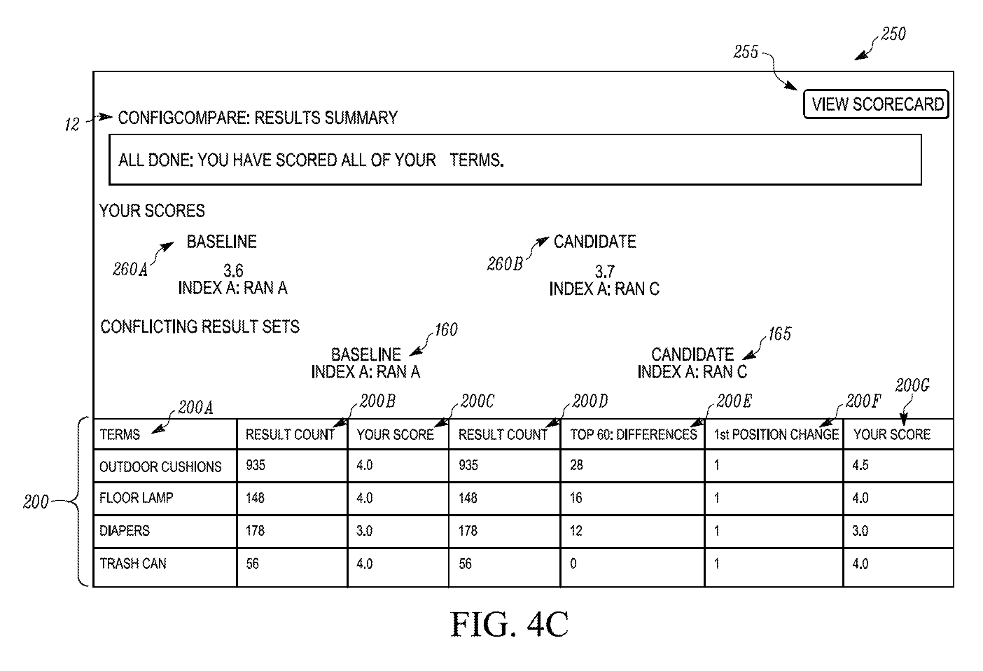

FIG. 4A illustrates a detailed comparison user interface 210 for the search evaluation system as described herein, according to some embodiments. FIG. 4B illustrates another portion of the detailed comparison user interface 210 for the search evaluation system as described herein, according to some embodiments. Aspects of FIGS. 4A-4B can be the same as or similar to aspects of FIGS. 2A-2D and FIGS. 3A-3B. For simplicity of this Specification, aspects which have been previously described will not be described in additional detail.

With reference to FIG. 4A, the detailed comparison user interface 210 includes a side-by-side breakdown of the test results for the baseline search configuration and the candidate search configuration. A summary 215 of the results is displayed at the top of the detailed comparison user interface 210. The summary 215 includes information similar to the summary table 200 (FIG. 3B). For example, the summary 215 includes a baseline search configuration name and a candidate search configuration name along with more specific information, such as, but not limited to, for which search term the summary 215 is displayed, a search result count for each of the search configurations, a number of changes to the top 60 search results (e.g., added or removed from the top 60 results), and a first position change. It is to be appreciated that the number “60” is one example and can be configurable based on a particular embodiment. The user can scroll through the detailed comparison user interface 210 in order to review the search results 230 and search details 240 (FIG. 4B) that identify why a search result was listed in a particular location within the search results. A portion of the detailed comparison user interface 210 includes a baseline-scoring summary 220 and a candidate scoring input 225. The baseline-scoring summary 225 includes a baseline score and comments input by the user with regard to the baseline score. The candidate scoring input 225 includes a score input 225A, a comment input 225B, and a submit button 225C. The candidate scoring input 225 can include additional features, such as an option to determine whether the user is automatically taken to another term's results set upon selection of the submit button 225C. The detailed comparison user interface 210 also includes a side-by-side view of the search results 230.

With reference to FIG. 4B, the search results 230 include search details 240A, 240B that identify how the search configuration selected (either the baseline search configuration or the candidate search configuration) was used to identify the order of the search results 230. The search results 230 can include a product image, a product name, and one or more results notification 232. For example, illustrated near the Candidate 1 result product image is a results indicator 232 with the text “Shift+4.” The results indicator 232 can highlight points of interest in the search results for the user. Points of interest can be, but are not limited to, indications that may impact scoring of a search configuration. For example, another results indicator 232 could be “Out of Stock,” because in some embodiments out of stock products should be removed from the search results 230. In the illustrated embodiment, the baseline search details 240A correspond to the baseline search configuration and “Product A” and the candidate search details 240B correspond to the candidate search configuration and “Product B.” The search details 240 can be the same or different for the baseline search configuration and the candidate search configuration. Though only a single product is displayed for each search configuration, it is to be appreciated that the user can navigate to other areas of the detailed comparison user interface 210 in order to review the search details 240 for other products returned in the search results 230. After reviewing the search details 240, the user can input a candidate score into the score input 225A (FIG. 4A) and provide comments regarding the candidate score selected in the comment input 225B (FIG. 4A).

It is to be appreciated that one or more additional aspects can be included in the detailed comparison user interface 210. For example, a progress indicator can be displayed to indicate to the user how many more terms remain to be scored, how many have already been scored, or the like. In some embodiments, the search term being tested may remain on the user interface even when the user scrolls.

FIG. 4C illustrates a score comparison results summary user interface 250 for the search evaluation system as described herein, according to some embodiments. Once the user has reviewed the search results 230 and provided a candidate score for the candidate search configuration for a particular term, the user may be presented with the score comparison results summary user interface 250. The score comparison results summary user interface 250 may only be presented when the user has completed scoring for all search terms for the candidate search configuration, according to some embodiments. The score comparison results summary user interface 250 includes a baseline average score 260A for the baseline search configuration and a candidate average score 260B for the candidate search configuration. The score comparison results summary user interface 250 includes the summary table 200 (FIG. 3B) which is updated to include the scoring the user provided, for the candidate search configuration.

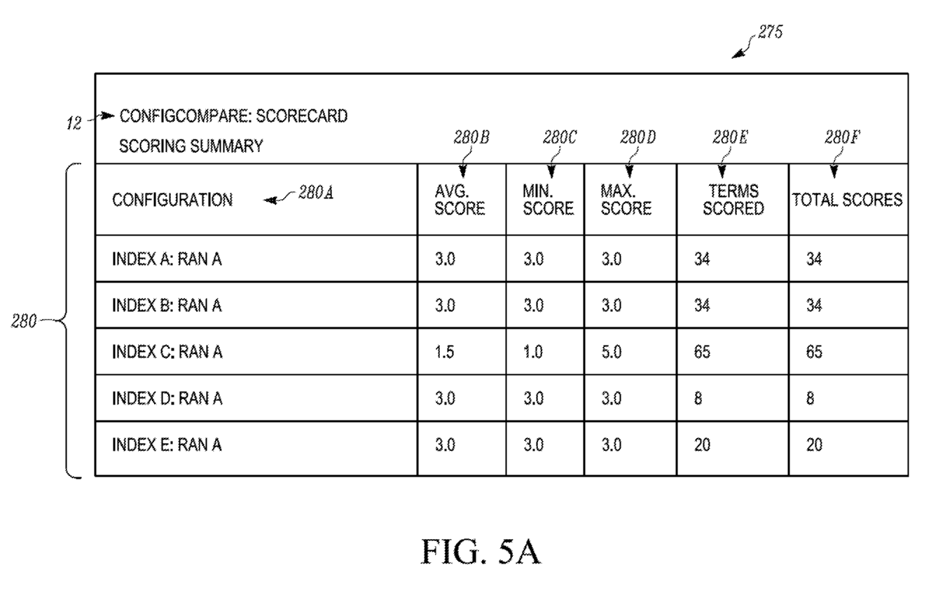

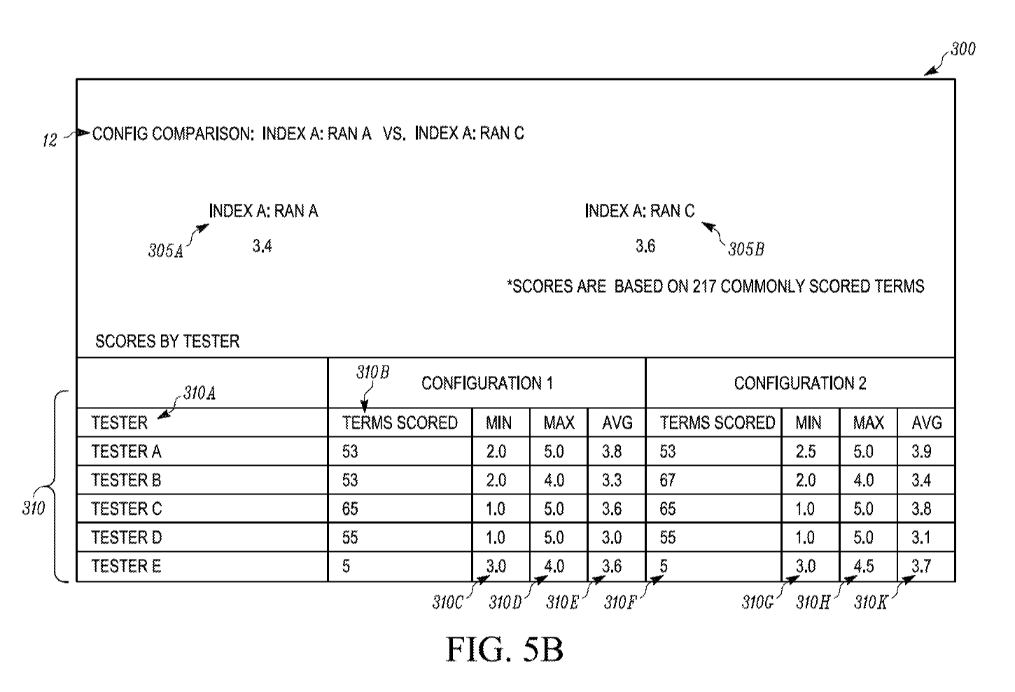

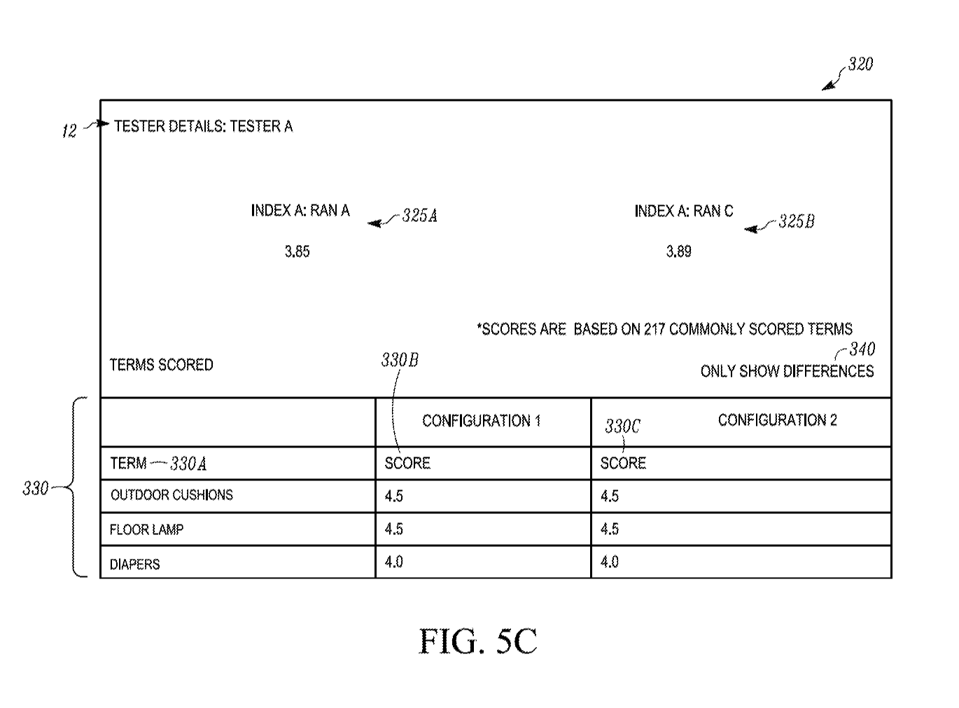

FIGS. 5A-5C illustrate summary scorecard user interfaces 275, 300, 320 for the search evaluation system as described herein, according to some embodiments. The summary scorecard user interfaces 275, 300, 320 can be used to review scores for all search configurations (e.g., for both baseline and search configurations) that have been tested. This can include those tested by a single user, or by all users of the search evaluation system. In some embodiments, this can inform a decision as to which search configuration provides the most relevant search results for a variety of search terms. The “winning” search configuration can be selected and may, for example, be used on a retailer's website.

With reference to FIG. 5A, the summary scorecard user interface 275 includes a scoring summary table 280 for all search configurations 280A. The summary scorecard user interface 275 may be scrollable. The scoring summary table 280 includes an average score 280B, a minimum score 280C, a maximum score 280D, a number of terms scored 280E, and a total number of scores 280F. The scoring summary table 280 can include fewer or additional columns. Particularly, the scoring summary table 280 can include any statistical information which may assist in differentiating between the search results for the various search configurations 280A. For example, a median score could be included.

With reference to FIG. 5B, the summary scorecard user interface 300 includes a breakdown of the scoring for two search configurations by user. The summary scorecard user interface 300 includes an average score 305A, 305B for each of the search configurations in the comparison. The average scores 305A, 3058 in the illustrated embodiment are only based on keywords tested and scored for search terms that were searched for each of the search configurations. The tester summary table 310 includes a more detailed breakdown of the scoring results for the search configurations by tester 310A. The tester summary table 310 includes a number of search terms scored 310B, 310F; a minimum score 310C, 310G; a maximum score 310D, 310H, and an average score 310E, 310K for each of the search configurations being compared. Though two search configurations are being compared, it is to be appreciated that more search configurations could be included in the comparison. Further, additional statistical information (such as, but not limited to a median score) could be included for each of the testers 310A.

With reference to FIG. 5C, the summary scorecard user interface 320 includes detailed scoring results for a particular tester 310A. In some embodiments, the user may be able to select one of the testers 310A in FIG. 5B in order to view the detailed scoring results in the summary scorecard user interface 320. The summary scorecard user interface 320 includes average scores 325A, 325B for the search configurations being compared. Similar to FIG. 5B, the calculation of the average scores 325A, 325B may be based only on terms that were scored for both of the search configurations. A term summary table 330 shows a breakdown of scores 330B, 330C by term 330A for each of the search configurations being compared. The user may be able to select a filter 340 in order to show terms 330A in the term summary table 330 that are scored differently between the search configurations being compared. The text corresponding to the filter 340 is generally selectable (e.g., a hyperlink, a button, or the like).

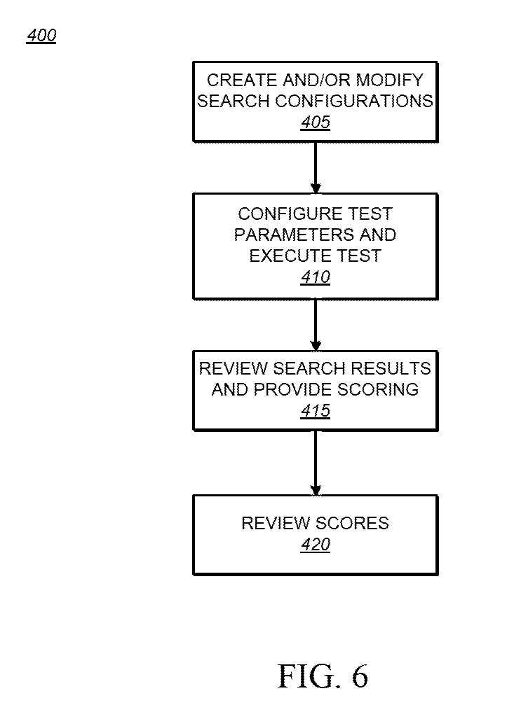

FIG. 6 is a flowchart for a method 400 to evaluate a search configuration using the search evaluation system described herein, according to some embodiments. The method 400 generally can be performed using the search evaluation system in accordance with the aspects described above with respect to FIGS. 1-5. The method 400 begins at 405 when a user creates and/or modifies one or more search configurations. As discussed above, this can include configuring one or more search indexes, one or more ranking strategies, and the one or more search configurations. It is to be appreciated that the user may skip 405 and use previously created search configurations in the method 400. In such case, the method 400 can alternatively begin at 410. At 410 the user configures one or more test parameters. This can include selecting an environment in which to execute the search evaluation, a baseline search configuration, a candidate search configuration, and/or uploading one or more search terms. Once configured, the test can be executed. At 415, the user reviews the search results and inputs her scoring evaluations for the candidate search configuration. At 420, the user can review scores for various search configurations provided by various users (e.g., testers). By reviewing the scores for the various search configurations and performed by the various testers, the user may be able to identify a search configuration that appears to provide relatively better results than the other search configurations. In some embodiments, the user can use the scoring to inform a decision as to which search configuration should be implemented, for example, on a search feature of a retail website.

FIG. 7 is a schematic diagram of an architecture for a computer device 500, according to an embodiment. The computer device 500 and any of the individual components thereof can be used for any of the operations described in accordance with any of the computer-implemented methods described herein.

The computer device 500 generally includes a processor 510, memory 520, a network input/output (I/O) 525, storage 530, and an interconnect 550. The computer device 500 can optionally include a user I/O 515, according to some embodiments. The computer device 500 can be in communication with one or more additional computer devices 500 through a network 540.

The computer device 500 is generally representative of hardware aspects of a variety of user devices 501 and a server device 535. The illustrated user devices 501 are examples and are not intended to be limiting. Examples of the user devices 501 include, but are not limited to, a desktop computer 502, a cellular/mobile phone 503, a tablet device 504, and a laptop computer 505. It is to be appreciated that the user devices 501 can include other devices such as, but not limited to, a personal digital assistant (PDA), a video game console, a television, or the like. In some embodiments, the user devices 501 can alternatively be referred to as client devices 501. In such embodiments, the client devices 501 can be in communication with the server device 535 through the network 540. One or more of the client devices 501 can be in communication with another of the client devices 501 through the network 540 in some embodiments.

The processor 510 can retrieve and execute programming instructions stored in the memory 520 and/or the storage 530. The processor 510 can also store and retrieve application data residing in the memory 520. The interconnect 550 is used to transmit programming instructions and/or application data between the processor 510, the user I/O 515, the memory 520, the storage 530, and the network I/O 540. The interconnect 550 can, for example, be one or more busses or the like. The processor 510 can be a single processor, multiple processors, or a single processor having multiple processing cores. In some embodiments, the processor 510 can be a single-threaded processor. In some embodiments, the processor 510 can be a multi-threaded processor.

The user I/O 515 can include a display 516 and/or an input 517, according to some embodiments. It is to be appreciated that the user I/O 515 can be one or more devices connected in communication with the computer device 500 that are physically separate from the computer device 500. For example, the display 516 and input 517 for the desktop computer 502 can be connected in communication but be physically separate from the computer device 500. In some embodiments, the display 516 and input 517 can be physically included with the computer device 500 for the desktop computer 502. In some embodiments, the user I/O 515 can physically be part of the user device 501. For example, the cellular/mobile phone 503, the tablet device 504, and the laptop 505 include the display 516 and input 517 that are part of the computer device 500. The server device 535 generally may not include the user I/O 515. In some embodiments, the server device 535 can be connected to the display 516 and input 517.

The display 516 can include any of a variety of display devices suitable for displaying information to the user. Examples of devices suitable for the display 516 include, but are not limited to, a cathode ray tube (CRT) monitor, a liquid crystal display (LCD) monitor, a light emitting diode (LED) monitor, or the like.

The input 517 can include any of a variety of input devices or means suitable for receiving an input from the user. Examples of devices suitable for the input 517 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 517 can be included for the user devices 501. In some embodiments the input 517 can be integrated with the display 516 such that both input and output are performed by the display 516.

The memory 520 is generally included to be representative of a random access memory such as, but not limited to, Static Random Access Memory (SRAM), Dynamic Random Access Memory (DRAM), or Flash. In some embodiments, the memory 520 can be a volatile memory. In some embodiments, the memory 520 can be a non-volatile memory. In some embodiments, at least a portion of the memory can be virtual memory.

The storage 530 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 530 is a computer readable medium. In some embodiments, the storage 530 can include storage that is external to the computer device 500, such as in a cloud.

The network I/O 525 is configured to transmit data via a network 540. The network 540 may alternatively be referred to as the communications network 540. Examples of the network 540 include, but are not limited to, a local area network (LAN), a wide area network (WAN), the Internet, or the like. In some embodiments, the network I/O 525 can transmit data via the network 540 through a wireless connection using WiFi, Bluetooth, or other similar wireless communication protocols. In some embodiments, the computer device 500 can transmit data via the network 540 through a cellular, 3G, 4G, or other wireless protocol. In some embodiments, the network I/O 525 can transmit data via a wire line, an optical fiber cable, or the like. It is to be appreciated that the network I/O 525 can communicate through the network 540 through suitable combinations of the preceding wired and wireless communication methods.

The server device 535 is generally representative of a computer device 500 that can, for example, respond to requests received via the network 540 to provide, for example, data for rendering a website on the user devices 501. The server 535 can be representative of a data server, an application server, an Internet server, or the like.

Aspects described herein can be embodied as a system, method, or a computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM). Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are examples only, with the true scope and spirit of the disclosure being indicated by the claims that follow.

What is claimed is:

1. An electronic search evaluation system, comprising:
an application that is loadable onto a user device, the user device including a display and an input;
a server in communication with the user device,
wherein the application, when loaded onto the user device, permits the user device to communicate with the server to send to the server a baseline search configuration, a candidate search configuration, and a plurality of search terms, and to receive from the server baseline search results and candidate search results for the plurality of search terms, and to cause display of the baseline search results and candidate search results on the display,
the server being communicable with the user device and configured to receive the baseline and candidate search configurations and search terms, identify the baseline and candidate search results, compare the baseline and candidate search results, and send the baseline and candidate search results to the application,
wherein the baseline and candidate search results sent to the application include a comparison marker to indicate whether the baseline and candidate search results are matching.

2. The electronic search evaluation system according to claim 1, wherein the server is communicable with one or more search engines, such that the server requests a search from the one or more search engines for the baseline search configuration and the candidate search configuration for each of the plurality of search terms, and receives the search results for each of the plurality of search terms from the one or more search engines.

3. The electronic search evaluation system according to claim 1, wherein the application makes available a configuration user interface which permits the user to create and/or modify one or more search configurations.

4. The electronic search evaluation system according to claim 1, wherein the application is configured to receive a search term list having a plurality of search terms therein.

5. The electronic search evaluation system according to claim 1, wherein the application makes available a detailed comparison user interface configured to display a side-by-side comparison of the baseline search results and the candidate search results for each of the plurality of search terms, and wherein the comparison marker indicates the baseline search results and the candidate search results are not matching.

6. The electronic search evaluation system according to claim 5, wherein the detailed comparison user interface includes an input means for receiving a candidate score for the candidate search results.

7. A method of evaluating a search configuration, the method comprising:
providing a search evaluation system that is loadable onto a user device having an input and a display, the search evaluation system permitting a user to create and/or modify search configurations, configure search evaluation parameters, execute search evaluations for a plurality of search terms, and review and score search results for the search configurations and the plurality of search terms;
receiving, by a server, the plurality of search terms, a baseline search configuration, and a candidate search configuration from the search evaluation system;
obtaining a baseline search results list and a candidate search results list for each of the plurality of search terms, wherein the baseline search results lists correspond to the baseline search configuration and the candidate search results lists correspond to the candidate search configuration;
comparing the baseline search results list with the candidate search results list for each of the plurality of search terms;
based on the comparing, generating a discrepancy list of search terms wherein the baseline search results list and the candidate search results lists are not the same; and
sending the discrepancy list and search details associated with the search terms in the discrepancy list to the user device for display on the display in a side-by-side breakdown.

8. The method according to claim 7, further comprising:
receiving baseline scores for the baseline search results list from the search evaluation system.

9. The method according to claim 7, wherein receiving the plurality of search terms includes receiving a search term list file.

10. The method according to claim 7, wherein receiving the plurality of search terms includes receiving an indication to use a plurality of stored search terms, wherein the plurality of stored search terms are stored in a search term database.

11. The method according to claim 7, wherein obtaining the baseline and candidate search results lists includes submitting a query to a search engine.

12. The method according to claim 7, wherein providing the baseline and candidate search results lists includes:
displaying, on the user device, a side-by-side breakdown of each of the baseline and candidate search results, the displaying including search details indicating how a search result was identified.

13. The method according to claim 7, further comprising providing scoring summaries that include providing scoring breakdowns for each of a plurality of candidate scores.

14. A graphical user interface (GUI) for a search evaluation system displayed on a display of a user device, the GUI comprising:
one or more servers connectable to a network and configured to provide a search evaluation system interface for evaluating a plurality of search configurations, the search evaluation system interface viewable on a user device and displaying a plurality of search results lists for a plurality of search terms and the plurality of search configurations, the plurality of search configurations including a baseline search configuration and a candidate search configuration, the plurality of search results lists including a baseline search result list and a candidate search result list for each of the plurality of search terms.

15. The GUI according to claim 14, wherein the baseline search result list and the candidate search result list are displayed side-by-side for each of the plurality of search terms.

16. The GUI according to claim 15, wherein the baseline search result list and the candidate search result list include search details identifying how a search term was ranked.

17. The GUI according to claim 14, wherein the GUI is configured to receive a candidate score associated with the candidate search result list.

18. The GUI according to claim 17, the GUI being further configured to display a score summary for each of the plurality of search terms, the score summary including the candidate score and a baseline score.

19. The GUI according to claim 17, wherein the GUI is configured to receive comments associated with the candidate score.

20. The GUI according to claim 17, wherein the GUI is accessible to a plurality of users, and the GUI displays a score summary including the candidate scale and a baseline score for each of the plurality of search terms for each of the plurality of users.
